(19) United States
(12) Patent Application Publication
(10) Pub. No.: US 2007/0220323 A1
(43) Pub. Date: Sep. 20, 2007

(54) System and method for highly available data processing in cluster system

(76) Inventor: Eiichi Nagata, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/543,877

(22) Filed: Oct. 6, 2006

(30) Foreign Application Priority Data
Feb. 22, 2006 (JP) 2006-045293

(51) Int. Cl. G06F 11/00

(52) U.S. Cl. 714/13

(57) ABSTRACT

Provided is a method of managing an active server in a computer system. According to this method, the standby server receives, from one of the active servers, a request for registration of the active server, the request including information about the active server and information about a recovery program that is executed when a failure occurs in the active server. The standby server stores, in a storage unit, the information about the active server and the information about the recovery program based on the received request for registration. And the standby server sends to the active server that has issued the request, information indicating that the active server has successfully been registered in the standby server.

### CLAIM OF PRIORITY

The present application claims priority from Japanese patent application 2006-045293 filed on Feb. 22, 2006, the content of which is hereby incorporated by reference into this application.

### BACKGROUND OF THE INVENTION

This invention relates to a technique of managing a configuration of computers in a computer system.

Clustering is one of technologies used to make a computer system highly available and, in a cluster system, a plurality of computers operating independently of one another are treated as a single computer. Cluster systems are roughly classified into scalable cluster systems which normally operate using all computers in a system and are degenerated at the time of a failure to continue operating, and standby cluster systems with standby computers which are put into operation when a failure occurs.

The standby cluster systems are further classified into at least four types, 1:1 standby, 1:1 mutual standby, N:1 standby, and N:M standby. An N:1 standby cluster system is composed of N active computers (i.e., active servers) and one standby computer (i.e., standby server). The N:1 standby type accomplishes high availability of the computer system and scalability in processing an application while keeping the cost of having a standby computer low. An N:M standby cluster system is composed of N active computers and M standby computers (usually, N>M). The N:M standby type can deal with failures up to and including M times in addition to possessing the advantages of the N:1 type. An example of this technology is disclosed in JP 2001-188684 A.

To provide a system with a plurality of active servers, proposed is the N:M standby cluster system in which one standby server recovers an unresolved transaction that was in progress when a failure occurred in one of the active servers and thus implements an application that was being provided by this active server.

### SUMMARY OF THE INVENTION

To add an active server to the above-mentioned N:M standby cluster system, information of the active server (including switching (i.e., failover) definitions, and a resource adapter necessary for recovery of a transaction) has to be set in advance in the standby server. This means an additional cost for the building of the standby server.

Moreover, the standby server has to be shut down once before the information of the active server to be added can be set.

Furthermore, the above-mentioned cluster system has no guarantee that a transaction is recovered correctly after a failure if the information of the active server to be added is set inaccurately.

This invention has been made in view of the above, and it is therefore an object of this invention to lower a cost of building a standby server that arises from adding an active server.

A representative aspect of this invention is an active server management method for a computer system having a plurality of active computers and at least one standby server, which, when a failure occurs in one of the active servers, recovers transaction processing that has been executed in the failed active server, and operation of the standby server includes: storing configuration management information which is used to manage the configurations of the active servers to be taken over and switching definitions which determine what cluster program is executed when a failure occurs in one of the active servers; upon reception of a request to register information of one of the active servers, registering information that is included in the received registration request in the configuration management information; extracting, from the information included in the received registration request, information that is necessary to execute the cluster program; registering the extracted information as the switching definitions; and, after finishing registering the configuration management information and the switching definitions, notifying the completion of registration of information of the active server.

Another representative aspect of this invention is an active server management method for a computer system with a plurality of active computers and at least one standby server which, when a failure occurs in one of the active servers, recovers transaction processing that has been executed in the failed active server, and operation of the standby server includes: storing configuration management information which is used to manage the configurations of the active servers to be taken over and switching definitions which determine what cluster program is executed when a failure occurs in one of the active servers; upon reception of a request to delete information of one of the active servers, deleting the switching definitions of the active server that is identified by the received deletion request; after deleting the switching definitions of the active server, deleting information of the active server that is identified by the received deletion request from the configuration management information; and, after finishing deleting the switching definitions and the configuration management information, notifying the completion of deletion of information of the active server.

According to this invention, cost caused by changing the configuration of an active server can be reduced.

### BRIEF DESCRIPTION OF THE DRAWINGS

The present invention can be appreciated by the description which follows in conjunction with the following figures, wherein:

FIG. 1 is a diagram showing a configuration example of a computer system according to a first embodiment;

FIG. 2 is a diagram showing an example of an active server management table;

FIG. 3 is a diagram showing an example of cluster program switching definitions;

FIG. 4 is a flow chart for active server registration processing;

FIG. 5 is a flow chart for active server deletion processing;

FIG. 6 is a configuration diagram of a computer system according to a second embodiment;

FIG. 7 is a diagram showing an example of a standby server registration management table according to the first embodiment;

FIG. 8 is a flow chart for active server registration state output processing;

FIG. 9 is a diagram showing an example of a standby server registration confirmation screen;

FIG. 10 is a flow chart for standby server configuration information output processing;

FIG. 11 is a diagram showing an example of an active server registration confirmation screen; and

FIG. 12 is a flow chart showing steps from detection of an application server failure to resolution of a transaction that has been in progress.

### DETAILED DESCRIPTION OF THE PREFERRED EMBODIMENTS

Embodiments of this invention will be described below with reference to the accompanying drawings.

### First Embodiment

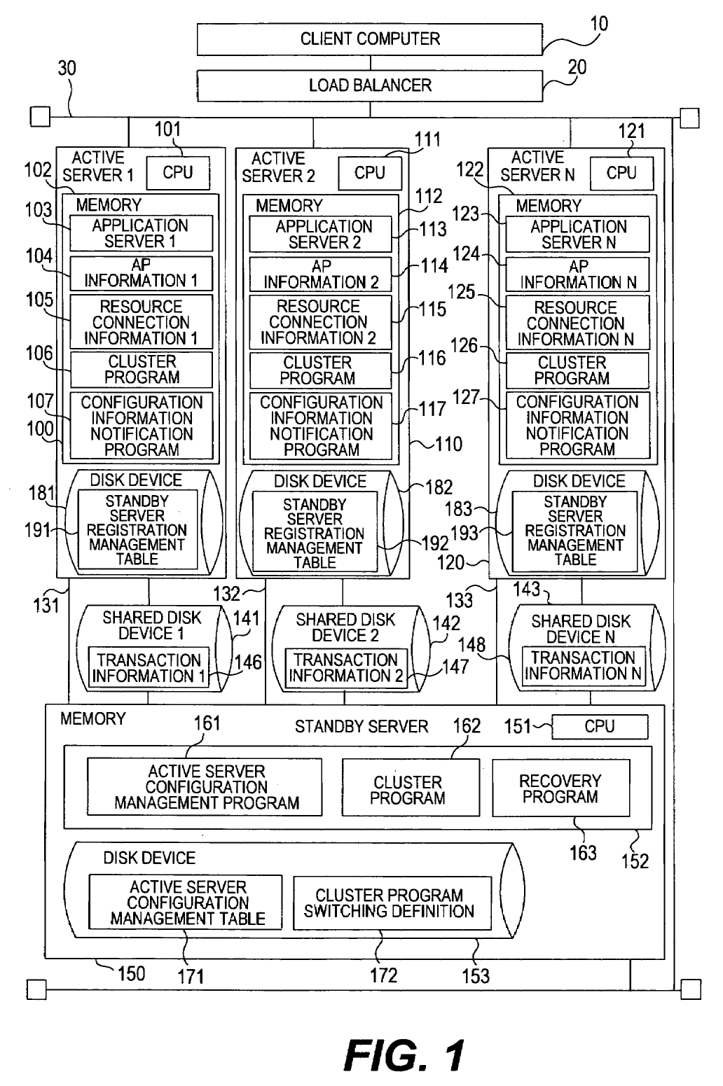

FIG. 1 is a configuration diagram of a computer system according to a first embodiment of this invention.

The computer system of this embodiment has a client computer 10, a load balancer 20, active servers 100, 110, and 120, shared disks 141, 142, and 143, and a standby server 150.

The client computer 10, the load balancer 20, the active servers 100, 110, and 120 and the standby server 150 are connected to one another via a network 30. The network 30 is a communication path along which data is transferred and can be a local area network (LAN) using a TCP/IP protocol, for example.

The client computer 10 is a computer with a processor (CPU), a memory, a communication interface, and an input/output device which are interconnected via an internal bus. The client computer 10 runs, for example, a client program (Web browser) and presents services provided by the active servers 100, 110, and 120 to users. FIG. 1 shows one client computer 10 but there may be more than one computer 10.

The load balancer 20 is a device that allocates requests from the client computer 10 among the active servers 100, 110, and 120 in accordance with preset conditions.

The active server 100 is a computer having a processor (i.e., CPU) 101, a memory 102, a disk device 181, a communication interface (not shown), and an input/output device. FIG. 1 shows three active servers, 100, 110, and 120, but there may be more or less than three active servers.

The processor 101 is a computational processing device for performing computation related to various programs that are executed in the active server 100.

The memory 102 is a memory storing programs and data that are necessary for the operation of the processor 101. The memory 102 in this embodiment particularly stores an application server program 103 executed in the active server 100, application information 104, resource connection information 105, a cluster program 106 and a configuration information notification program 107.

The application server program 103 is a program that processes requests from the client computer 10. The processor 101 executes the application server program 103, thereby causing the active server 100 to operate as Application Server One. When the processor 101 executes a WEB server program, for example, the active server 100 operates as a WEB server as a result. The description here takes as an example an application server and a WEB server, but the embodiment is not limited thereto.

The active server 100 in FIG. 1 contains only one application server program 103. Alternatively, the memory 102 may store a plurality of application server programs to be executed by the processor 101, so that the active server 100 operates as different application servers.

The application information 104 contains information about an application program that is run on the active server 100. The resource connection information 105 is information used by an application program to access various resources (i.e., databases).

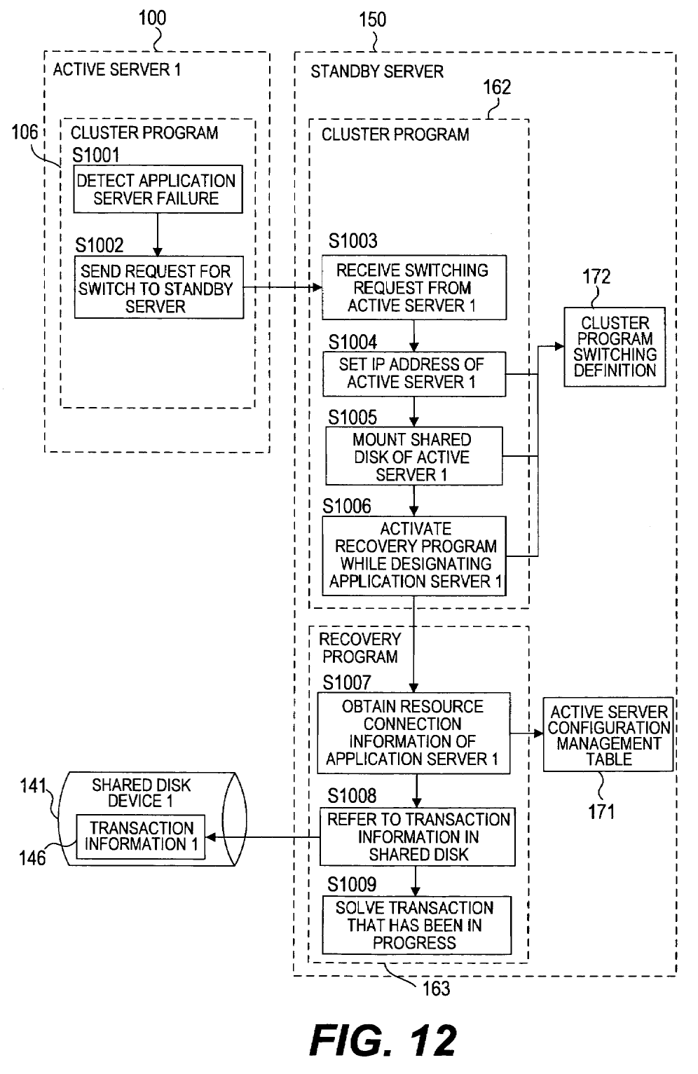

The cluster program 106 manages a cluster system composed of the active servers 100, 110, and 120 and the standby server 150. To be specific, when a failure occurs in the active server 100, the cluster program 106 makes the standby server 150 take over an application that has been executed in the active server 100. When the active server 100 recovers from the failure, the cluster program 106 restores the service application that has been taken over by the standby server 150. What processing is executed upon occurrence of a failure in one of the active servers 100, 110, and 120 will be described in detail with reference to FIG. 12.

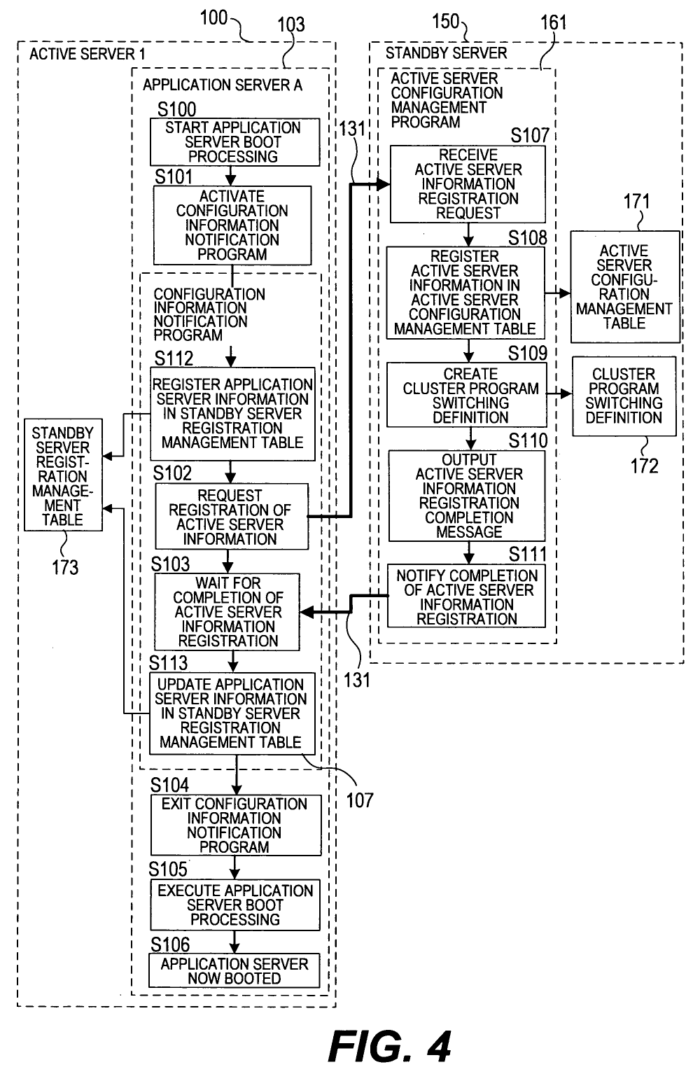

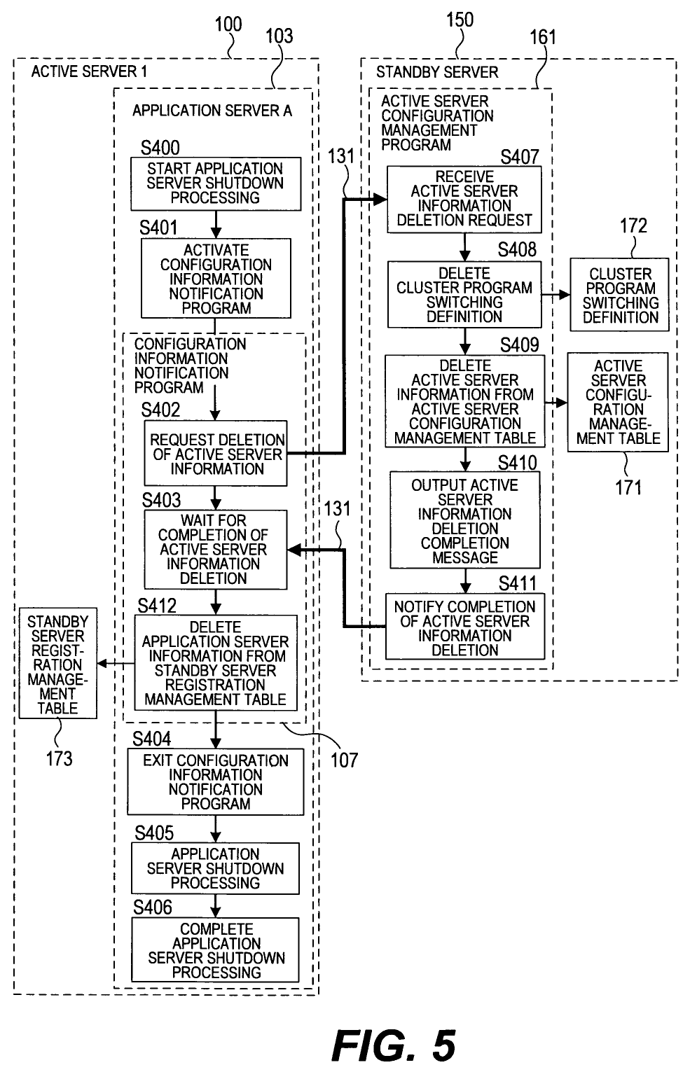

The configuration information notification program 107 notifies the standby server 150 of the configuration of the active server 100, 110, or 120 when this active server is booted as shown in FIG. 4 and, when the active server 100, 110, or 120 is shut down, notifies standby server 150 of deletion of this active server as shown in FIG. 5.

The disk device 181 is a hard disk drive storing programs and data necessary for the operation of the processor 101. The disk device 181 in this embodiment particularly stores a standby server registration management table 191.

The communication interface of the active server 100 is connected to the load balancer 20 via the network 30, and exchanges data with the client computer 10. The communication interface is connected to the standby server 150 via an active server information notification line 131, and is also connected to the shared disk 141.

The input/output device of the active server 100 is a keyboard, a display device, and the like which provide a user interface. Instead of having an input/output device, the active server 100 may be made accessible through a management terminal (not shown) that is connected to the active server 100 via the network 30.

The active servers 110 and 120 have the same configuration as that of the active server 100 except for points given below, and detailed descriptions on the active servers 110 and 120 are therefore omitted. A memory 112 of the active server 110 stores an application server program 113, which is executed by a processor 111 to cause the active server 110 to operate as Application Server Two. A memory 122 of the active server 120 stores an application server program 123, which is executed by a processor 121 to cause the active server 120 to operate as Application Server Three.

The active servers 100, 110, and 120 may be built in different pieces of hardware or the same hardware. The active servers and the standby server may be virtual computers. Processes, objects, or threads may serve as the active servers and the standby server.

The standby server 150 is a computer having a processor (i.e., CPU) 151, a memory 152, a disk device 153, a communication interface (not shown), and an input/output device.

The processor 151 is a computational processing device for performing computation related to various programs that are executed in the standby server 150.

The memory 152 is a memory storing programs and data that are necessary to the operation of the processor 151. The memory 152 in this embodiment particularly stores an active server configuration management program 161 executed in the standby server 150, a cluster program 162 and a recovery program 163.

The active server configuration management program 161 manages the configurations of the active servers 100, 110, and 120. The cluster program 162 manages the cluster system that is composed of the active servers 100, 110, and 120 and the standby server 150. To be specific, when a failure occurs in one of the active servers 100, 110, and 120, the cluster program 162 boots an application server on the standby server 150, so that the standby server 150 takes over an application that has been executed in the failed active server 100.

The recovery program 163 performs processing when a failure occurs in one of the active servers 100, 110, and 120 to complete data that has been in the middle of being processed in the failed active server and to recover the data. For example, in a case where a transaction is being executed in the active server 100 when a failure occurs in the active server 100, the recovery program 163 completes this transaction.

The disk device 153 is a hard disk drive storing programs and data necessary for the operation of the processor 151. The disk device 153 in this embodiment particularly stores an active server configuration management table 171 and cluster program switching definitions 172 which are used by the processor 151.

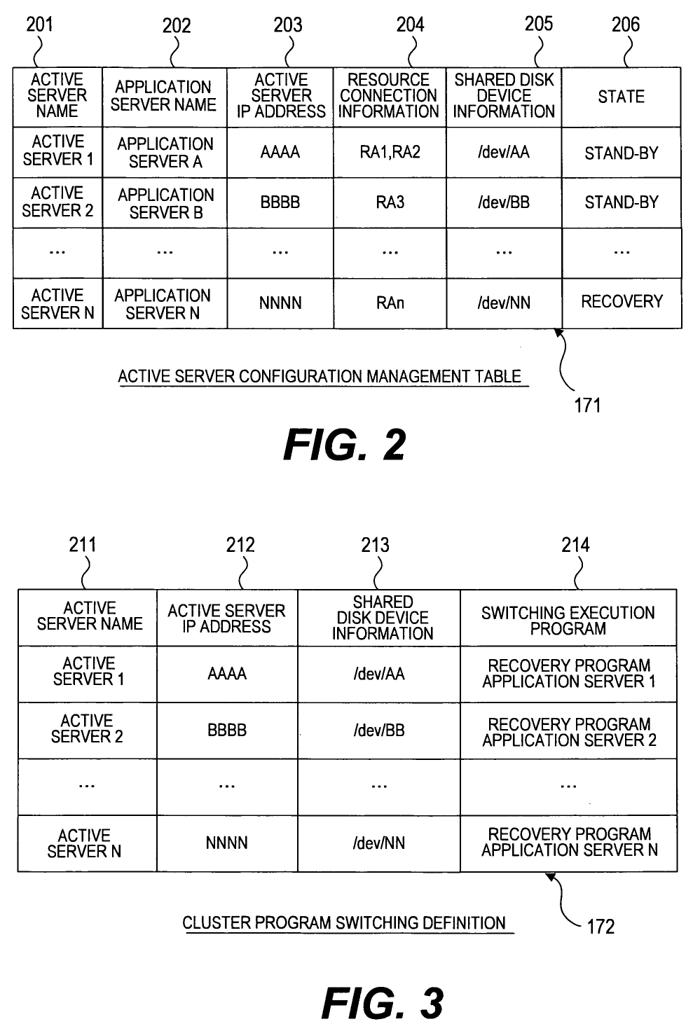

The active server configuration management table 171 is used by the active server configuration management program 161 to manage the configurations of the active servers. Details of the active server configuration management table 171 will be described with reference to FIG. 2. The cluster program switching definitions 172 are used by the cluster program 162 to manage the cluster system. Details of the cluster program switching definitions 172 will be described with reference to FIG. 3.

The communication interface of the standby server 150 is connected to the active servers 100, 110, and 120 through an active server information notification line 131. An active server configuration management program 161 of the standby server 150 exchanges information with the active servers 100, 110, and 120 via the active server information notification line 131. The communication interface is also connected to the shared disk devices 141, 142, and 143.

The input/output device of the standby server 150 is a keyboard, a display device, and the like which provide a user interface. Instead of having an input/output device, the standby server 150 may be made accessible through a management terminal (not shown) that is connected to the standby server 150 via the network 30.

The standby server 150 may be built in a piece of hardware different from the one where one of the active servers 100, 110, and 120 is built, or may be built in the same hardware where one of the active servers 100, 110, and 120 is built. The standby server 150 and the active servers 100, 110, and 120 may be built in the same hardware by way of virtual computers.

The shared disks 141, 142, and 143 are storage systems having disk drives and disk control units. The shared disks 141, 142, and 143 may constitute a redundant array of independent disks (RAID) structure from a plurality of disk drives, thereby giving redundancy to data stored therein. In this way, a failure in some of the disk drives does not lead to the loss of stored data, and the shared disks 141, 142, and 143 can be improved in reliability.

The shared disk 141 is connected to the active server 100 and the standby server 150, and is accessible to both of the servers 100 and 150. Normally, the active server 100 accesses the shared disk 141 and, after a system switch is made due to a failure in the active server 100, the standby server 150 accesses the shared disk 141 to use the shared disk 141 for processing of recovering the active server 100.

In the same way, the shared disk 142 is connected to the active server 110 and the standby server 150, and is accessible to both of the servers 110 and 150. The shared disk 143 is connected to the active server 120 and the standby server 150, and is accessible to both of the servers 120 and 150.

The shared disks 141, 142, and 143, respectively, store databases referred to by the active servers 100, 110, and 120, and transaction information 146, 147, and 148. An example of the transaction information is object transaction service (OTS) information.

Communication paths that connect the shared disks 141, 142, and 143 with the servers 100, 110, 120, and 150 are networks suitable for large-capacity data communications. For example, storage area networks (i.e., SANs) employing a fibre channel (FC) protocol in communications or IP-SANs employing an Internet SCSI (iSCSI) protocol in communications can be used as the communication paths. The shared disks 141, 142, and 143 may be disks having a sharing function or may be disks accessible through the servers.

FIG. 2 shows a configuration example of the active server configuration management table 171 in this embodiment.

The active server configuration management table 171 is a table holding information of an application server that is registered in the standby server 150, and contains an active server name (i.e., host name) 201, an application server name 202, an active server IP address 203, resource connection information 204, shared disk device information 205 and a state 206.

Information registered in the active server configuration management table 171 is sent from an active server that is newly added through active server registration processing, which will be described later with reference to FIG. 4.

The active server name (i.e., host name) 201 indicates a name assigned to each of the active servers 100, 110, and 120. The application server name 202 indicates a name assigned to an application server that is built in the active server 100 identified by the active server name 201.

The active server IP address 203 indicates an address assigned to each of the active servers 100, 110, and 120 to be used throughout the network. The resource connection information 204 indicates information of resources connected to the application server that is identified by the application server name 202 of the entry in question.

The shared disk device information 205 indicates to where a shared disk device is mounted that is accessible to the application server identified by the application server name 202 of this entry.

The state 206 indicates the operation state of the application server identified by the application server name 202 of this entry. At least four states, “stand-by”, “waiting for recovery”, “recovery” and “recovery completed”, can be recorded as the state 206. “Stand-by” indicates that the application server is operating normally whereas the standby server 150 is not in operation. “Waiting for recovery” indicates that the application server has experienced a failure and is waiting for recovery processing. “Recovery” indicates that the application server is executing the recovery processing. “Recovery completed” indicates that the recovery processing of the application server has been finished normally.

Information held in the active server configuration management table 171 is displayed on the input/output device (i.e., display device) when the active server configuration management table 171 stored in the disk device 153 is read upon reception of an active server management information display command entered through the input/output device.

FIG. 3 shows an example of the cluster program switching definitions 172 in this embodiment.

The cluster program switching definitions 172 are information referred to when the cluster program 162 is executed, and contains an active server name (i.e., host name) 211, an active server IP address 212, shared disk device information 213 and a switching execution program 214.

The cluster program switching definitions 172 are extracted from information that is registered in the active server configuration management table 171 through the active server registration processing described later with reference to FIG. 4.

The active server name (i.e., host name) 211 is the same as the active server name 201 of the active server configuration management table 171 in FIG. 2, and indicates a name assigned to the active server 100, 110, or 120 whose service application is taken over by the standby server 150.

The active server IP address 212 is the same as the active server IP address 203 of the active server configuration management table 171 of FIG. 2, and indicates an address on the network assigned to the active server 100, 110, or 120 whose service application is taken over by the standby server 150. The active server IP address 212 is used to identify which active server is suffering a failure, and an application that has been executed in the identified active server is taken over by the standby server 150.

The shared disk device information 213 is the same as the shared disk device information 205 of the active server configuration management table 171 of FIG. 2, and indicates where a shared disk device is mounted that is accessible to an application server in the active server identified by the active server name 211 of the entry in question. The shared disk device information 213 is used by the standby server 150 to access transaction information 146 stored in the shared disk in order to take over an application that has been executed in the application server of the active server identified by the active server name 211 of this entry.

The switching execution program 214 indicates what program is executed in the active and standby servers that constitute the cluster after a switch from a failed active server to the standby server. The recovery program 163 for recovering transaction processing is set as the switching execution program 214 in this embodiment. An application server name is recorded along with the program 163 as an argument of the program.

The cluster program switching definitions 172 in this embodiment have a table format, but may have a text format or an XML format instead as long as the same information as in the table format is defined.

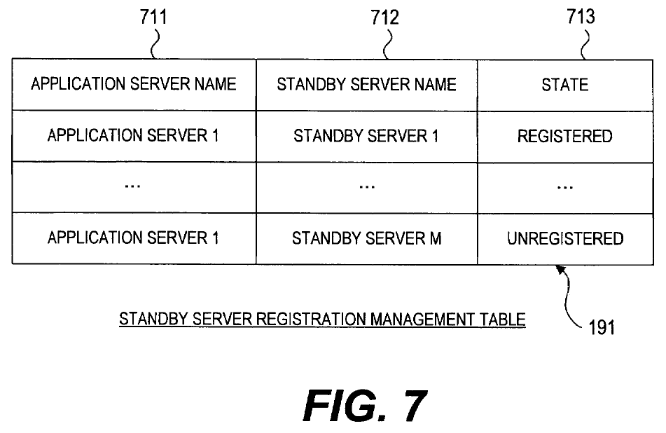

FIG. 7 shows an example of the standby server registration management table 191 in this embodiment.

The standby server registration management table 191 is a table holding information of an application server that is active in its own active server, and contains an application server name 711, a registration destination standby server name 712, and a registration state 713.

The application server name 711 indicates a name assigned to an application server to be registered in the standby server 150, and is the same information as the application server name 202 of the active server configuration management table 171.

The standby server name 712 indicates a name assigned to the standby server 150 in which this application server is registered.

The state 713 indicates whether or not this application server has been registered in the standby server. Either “registered” or “unregistered” is written as the state 713. “Unregistered” indicates that registration to the standby server has not been completed. “Registered” indicates that registration of this application server to the standby server has been completed and the application server is being monitored.

FIG. 4 is a flow chart for active server registration processing in this embodiment.

The application server program 103 of the active server 100 receives a request to boot the application server from the input/output device (or management terminal) of the active server 100, and starts application server boot processing (S100).

First, the application server program 103 activates the configuration information notification program 107 to notify the standby server 150 of registration of active server information (S101).

The configuration information notification program 107 activated registers, in a standby server registration management table 173, information of the application server to be registered (S112) and requests, through the active server information notification line 131, the standby server 150 to register active server information (S102). To be specific, the configuration information notification program 107 sends the active server name 201, the application server name 202, the active server IP address 203, the resource connection information 204 and the shared disk device information 205 as data to be recorded in the active server configuration management table 171 to the active server configuration management program 161. An application server boot request may specify which one of standby servers constituting the cluster is requested to register the active server information.

After issuing a request for registration of active server information, the configuration information notification program 107 enters an active server registration completion waiting state and waits for the standby server 150 to send a notification of completion of active server information (S103).

In a case where the standby server 150 or the active server configuration management program 161 is not active at the time the active server registration request is issued (S102) and the registration request fails, the registration request may be issued repeatedly until successfully received. In this way, once the standby server 150 becomes ready to receive a registration request, active server information is registered as requested, thus ensuring that failover succeeds when a failure occurs.

Alternatively, when an application server registration request is not received at first attempt, the request may be repeated on the background while proceeding to executing application server boot processing (S105) until the booting of the application server is completed (S106). Another option is to display a message informing that the standby server 150 or the active server configuration management program 161 is “inactive” on the output device (i.e., display device) of the active server 100. Then, after the booting of the application server is completed (S106), the configuration information notification program 107 is activated to request registration of an unregistered active server. In this way, the registration request is received and registration processing is started as soon as the standby server becomes ready to receive registration requests.

The active server configuration management program 161 receives an active server information registration request (S107) and registers the received active server information in the active server configuration management table 171 (S108). At this point, “monitored” is set as the initial value of the state 206.

The active server configuration management program 161 then creates the cluster program switching definitions 172 from the received active server information and registers the created definitions (S109). To be specific, the active server name 201, the active server IP address 203 and the shared disk device information 205 are extracted from the received active server information, and are registered as the cluster program switching definitions 172. At the same time, in the field for the switching execution program 214, a recovery program is registered as a program to be executed after switching, along with the name of a server to be recovered through the recovery program.

Thereafter, the active server configuration management program 161 notifies the completion of the active server registration (S110). To be specific, a message “registration of Active Server One completed” is displayed on the output device (i.e., display device) of the standby server 150. The active server configuration management program 161 also outputs the name of the active server whose registration has just been completed to a log file.

The active server configuration management program 161 then notifies the configuration information notification program 107 of the completion of the active server information registration through the active server information notification line 131 (S111).

The configuration information notification program 107 that is in the active server registration completion waiting state (S103) receives an active server information registration completion notification from the active server configuration management program 161, and changes the state 713 of the application server that has just been registered from “unregistered” to “registered”, thereby updating the standby server registration management table 173 (S113). The processing by the configuration information notification program 107 is thus ended.

As the processing by the activated configuration information notification program 107 is completed, the application server program 103 notifies the completion of the active server registration (S104). To be specific, a message “registration to Standby Server One completed” is displayed on the output device (i.e., display device) of the active server 100. The application server program 103 may also output the identifier of the standby server that has just completed the registration to a log file. By referring to this log, it is possible to learn which standby server an active server is registered in.

After the registration of the active server information in the standby server 150 is completed, the application server program 103 executes application server boot processing to start providing the service (S105).

The application server program 103 then displays a message informing the completion of the application server boot processing on the display device of the active server 100 (S106).

After receiving an active server information registration request (S107), the active server configuration management program 161 may send, to the active server 100 which has issued the request, information indicating that the requested registration cannot be performed due to the registration state, processing performance, resource amount, or the like of the standby server. This makes it possible to retry the registration processing or notify the system administrator of the fact, thereby enhancing the reliability of the computer system. When the configuration information notification program 107 that is in the active server registration completion state (S103) is notified of the fact that the requested registration cannot be performed, the configuration information notification program 107 displays a message “registration to standby server denied” with a reason why the active server information cannot be registered on the output device (i.e., display device) of the active server 100.

FIG. 5 is a flow chart for active server deletion processing in this embodiment.

The application server program 103 of the active server 100 receives a request to shut down the application server from the input device (or management terminal) of the active server 100, and starts application server shutdown processing (S400).

First, the application server program 103 activates the configuration information notification program 107 to notify the standby server 150 of deletion of active server information (S401).

The activated configuration information notification program 107 requests, through the active server information notification line 131, the standby server 150 to delete active server information (S402). To be specific, the configuration information notification program 107 sends a deletion request containing the identifier of an application server whose data is to be deleted from the active server configuration management table 171 to the active server configuration management program 161.

After issuing the active server information deletion request, the configuration information notification program 107 enters an active server deletion completion waiting state and waits for the standby server 150 to send an active server information deletion completion notification (S403).

The active server configuration management program 161 receives the active server information deletion request (S407) and deletes, from the cluster program switching definitions 172, data of the application server, which is requested to be deleted (S408). The active server configuration management program 161 then deletes, from the active server configuration management table 171, information of the application server, which is requested to be deleted (S409).

The cluster program switching definitions 172 are deleted before the active server configuration management table 171 in order to avoid putting the cluster program into operation and executing a switch to the standby server in the case where a failure occurs in the application server during the deletion processing.

Thereafter, the active server configuration management program 161 notifies the completion of the active server deletion (S410). To be specific, a message “deletion of Active Server One completed” is displayed on the output device (i.e., display device) of the standby server 150. The active server configuration management program 161 also outputs the name of the active server whose deletion has just been completed to a log file.

The active server configuration management program 161 then notifies the configuration information notification program 107 of the completion of the active server information deletion through the active server information notification line 131 (S411).

When the configuration information notification program 107 that is in the active server information deletion completion waiting state (S403) receives an active server information deletion completion notification from the active server configuration management program 161, the configuration information notification program 107 deletes, from the standby server registration management table 173, information of the application server that has just been deleted, thereby updating the standby server registration management table 173 (S412). The processing by the configuration information notification program 107 is thus ended.

As the processing by the activated configuration information notification program 107 is completed, the application server program 103 notifies the completion of the active server information deletion (S404). To be specific, a message “deletion from Standby Server One completed” is displayed on the output device (i.e., display device) of the active server 100. The application server program 103 may also output the identifier of the standby server from which an active server information has just been deleted to a log file. The history of registering standby servers can be known by referring to the log. The log also shows whether registration of the active server information to the standby server is in progress at present.

After the deletion of the active server information in the standby server 150 is completed, the application server program 103 executes application server shutdown processing to start providing the service (S405).

The application server program 103 then displays a message informing the completion of the application server shutdown processing on the display device of the active server 100 (S406).

As described above, the standby server 150 in the first embodiment executes the active server configuration management program 161. The active server 100 sends active server information to the active server configuration management program 161 of the designated standby server 150 when an application server is booted. The active server configuration management program that has received the active server information updates information in the cluster program switching definitions 172 to prepare for a recovery processing request sent from the active server.

This reduces the cost in registering active server configuration information in the standby server. This also prevents erroneous setting of the standby server from leading to a failure of active server recovery processing.

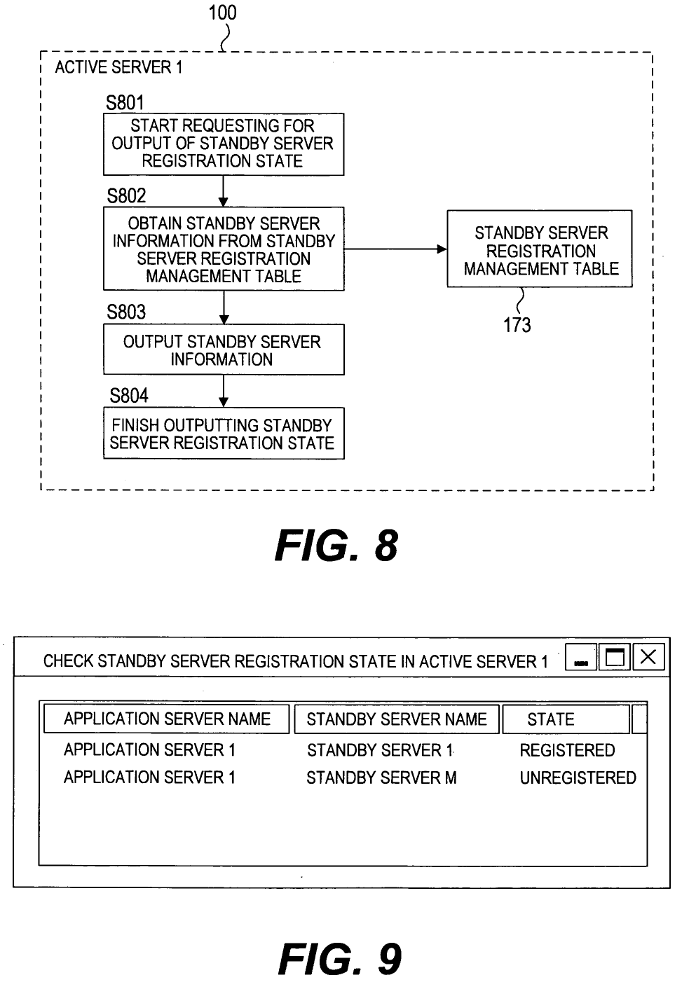

FIG. 8 is a flow chart showing standby server registration management information display processing.

The standby server registration management information display processing is executed when a request to output a registration state in the standby server 150 is received from the input device (or management terminal) of the active server in the form of a table display command or the like (S801).

The processor 101 of the active server 100 first obtains, from the standby server registration management table 173, the application mane 711, the standby server name 712, and the state 713 (S802). The obtained standby server information is displayed on the input/output device (i.e., display device) (S803), whereby standby server registration state output processing is completed (S804).

Through the standby server registration management information display processing, the application name 711, the standby server name 712, and the state 713 that are registered in the standby server registration management table 173 are displayed on the display device as shown in FIG. 9.

In obtaining the registration state (S802), the active server may check the registration state with the standby server in which the active server has been registered. A registration state check made between an active server and a standby server in this way enhances the reliability.

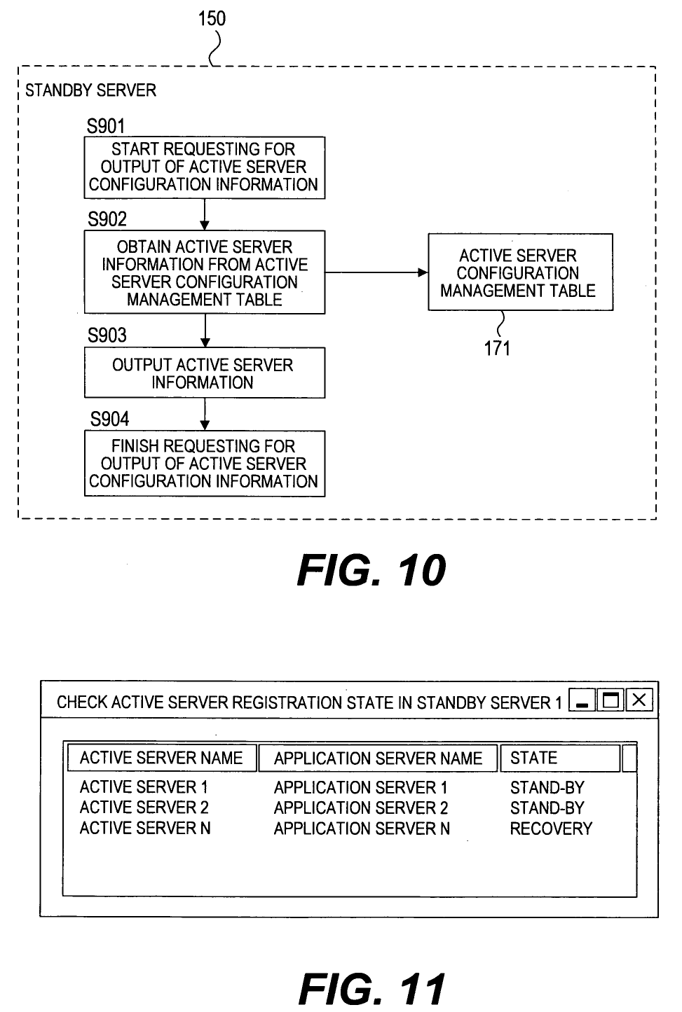

FIG. 10 is a flow chart showing active server configuration information display processing.

The active server configuration information display processing is executed when a request to output active server configuration information is received from the input device (or management terminal) of the standby server in the form of an active server configuration information display command or the like (S901).

The processor 151 of the standby server 150 first obtains information from the active server configuration management table 171 (S902). To be specific, the active server name 201, the application server name 202, and the state 206 are obtained from the active server configuration management table 171.

The obtained active server information is displayed on the input/output device (i.e., display device) (S903), whereby active server configuration information output processing is completed (S904).

Through the active server configuration information display processing, the active server name 201, the application server name 202, and the state 206 that are registered in the active server configuration management table 171 are displayed on the display device as shown in FIG. 11, for example.

Processing executed when a failure occurs in the active servers 100, 110, and 120 will be described next.

The standby server 150 performs, for each of the active servers 100, 110, and 120, processing which includes monitoring the operation state of the active server 100, 110, or 120 at regular intervals, recovering a transaction of an active server in which a failure has occurred, and then continuing monitoring the operation of the active server instead of taking over the processing of the active server. In this way, the standby server 150 recovers a transaction of an active server in which a failure has occurred as soon as the failure is detected, and transaction recovery is carried out without a delay. An unfinished transaction of the active server is thus prevented from interrupting service application processing of other active servers.

To give a specific description on the above processing, the cluster program 106, 116, or 126 detects a failure in the active server 100, 110, or 120 (S1001), and sends a switching request to the cluster program 162 of the standby server 150 (S1002).

The cluster program 162 of the standby server 150 receives the switching request (S1003), and refers to the active server IP address 212 in the cluster program switching definitions 172 to set the IP address of the active server in which a failure has occurred (S1004). The cluster program 162 then refers to the shared disk device information 213 in the cluster program switching definitions 172 to mount the shared disk device 141, 142, or 143 (S1005), and refers to the switching execution program 214 to activate the recovery program 163 while designating the defined application server as the recipient of the recovery program 163 (S1006).

The recovery program 163 obtains, from the active server configuration management table 171, resource connection information that is associated with the application server name designated when activated (S1007), and connects to the relevant database. The recovery program then refers to the transaction information 146, 147, or 148 stored in the mounted shared disk (S1008), and solves the transaction that has been in progress at the time of the failure (S1009).

In the case where another recovery program is being executed and it is not possible to execute different recovery programs simultaneously, the recovery processing 163 that has been activated later may wait for the recovery program 163 that has been activated first to complete its recovery processing before executing the program. This enables the computer system to deal with failures in a plurality of active servers.

According to this method, to degenerate an active server in which a failure has occurred, the standby server instructs the load balancer to remove the active server from a component active server list. This prevents the load balancer from sending an invalid processing request to the server in which a failure has occurred and to the failover standby server that has taken over the IP address of the active server to recover a transaction of the active server.

To cancel the degeneration of an active server that has recovered from a failure and become ready to operate, the standby server sends a message to instruct the load balancer to add the active server to the component active server list. This allows the load balancer to send a processing request to the active server which is now ready to resume operation, and the load is balanced.

### Second Embodiment

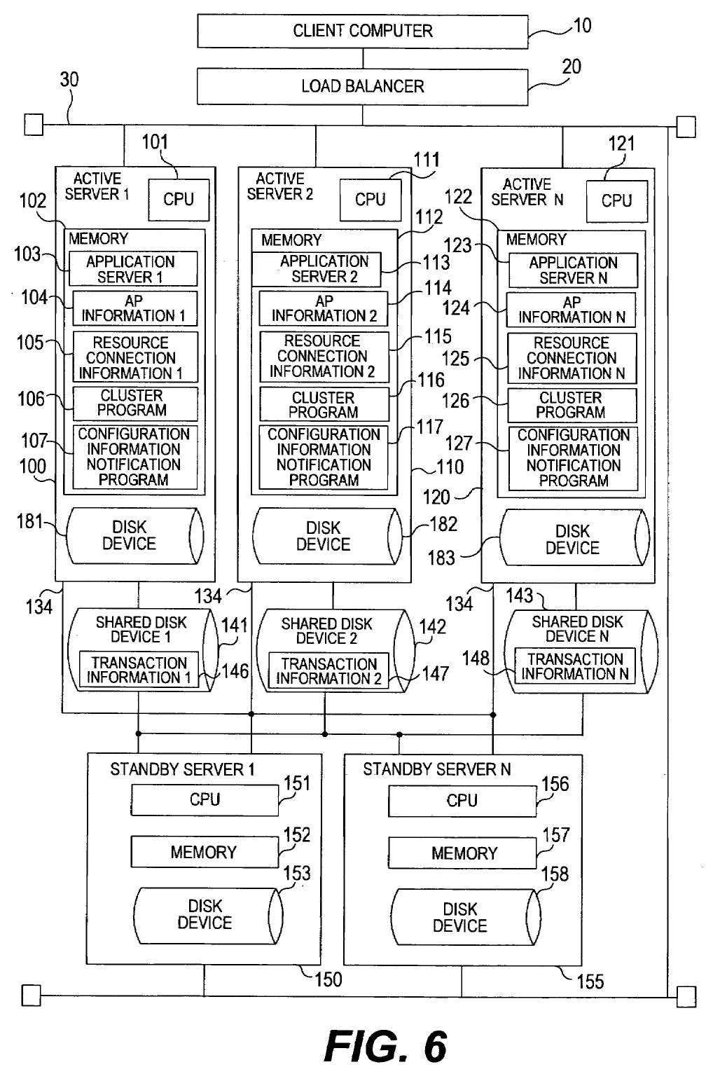

FIG. 6 shows a configuration example of a computer system according to a second embodiment of this invention.

The computer system of the second embodiment has M standby servers unlike the computer system of the first embodiment described above with reference to FIG. 1. In the second embodiment, components identical to those described in the first embodiment with reference to FIG. 1 will be denoted by the same reference symbols and detailed descriptions on such components will be omitted.

The computer system of this embodiment has the client computer 10, the load balancer 20, active servers 100, 110, and 120, shared disks 141, 142, and 143, and a plurality of standby servers 150 and 155.

The client computer 10 is a computer with a processor (i.e., CPU), a memory, a communication interface, and an input/output device that are interconnected by an internal bus.

The load balancer 20 is a device that allocates requests from the client computer 10 among the active servers 100, 110, and 120 in accordance with preset conditions to even out the load among the active servers 100, 110, and 120.

The active server 100 is a computer having the processor (i.e., CPU) 101, the memory 102, the disk device 181, a communication interface (not shown), and an input/output device.

The standby server 150 is a computer having a processor (i.e., CPU) 151, the memory 152, the disk device 153, a communication interface (not shown), and an input/output device. In the same way, the standby server 155 is a computer having a processor (i.e., CPU) 156, a memory 157, a disk device 158, a communication interface (not shown), and an input/output device.

The processor 156 operates the same way as the processor 151 of the standby server 150. The memory 157 stores the same information as the memory 152 of the standby server 150. The disk device 158 stores the same information as the disk device 153 of the standby server 150.

The communication interface of the standby server 150 is connected to the active servers 100, 110, and 120 through an active server information notification line 134. An active server configuration management program of the standby server 150 exchanges information with the active servers 100, 110, and 120 via the active server information notification line 134. The communication interface of the standby server 150 is also connected to the shared disk devices 141, 142, and 143.

In the same way, the communication interface of the standby server 155 is connected to the active servers 100, 110, and 120 through an active server information notification line 134. An active server configuration management program of the standby server 155 exchanges information with the active servers 100, 110, and 120 via the active server information notification line 134. The communication interface of the standby server 155 is also connected to the shared disk devices 141, 142, and 143.

The active server information notification line 134 that connects the active servers 100, 110, and 120 with the standby servers 150 and 155 may be a network. For instance, the active server information notification line 134 can be a network that is physically or logically the same as the network 30.

Communication paths connecting the standby servers 150 and 155 with the shared disks 141, 142, and 143 may be networks. For example, the communication paths can be a network that is physically or logically the same as the network 30.

The standby server 155 can thus perform the same operation as the standby server 150. When a failure occurs in Application Server A, B, or N, the active server configuration management program 161 follows a preset procedure to determine which standby server is to take over execution of an application, and hands over the service application of the active server to the standby server 150 or 155.

The standby servers 150 and 155 may be built in different pieces of hardware or the same hardware. The standby servers 150 and 155 may be built in the same hardware by way of virtual computers. This enables one physical computer to have an active server and a standby server, thereby lowering the cost.

Described next are active server registration processing in the second embodiment with reference to FIG. 4, and active server deletion processing in the second embodiment with reference to FIG. 5.

In the active server registration processing of FIG. 4, an application server program 103 of the active server 100 activates the configuration information notification program 107 (S101). The configuration information notification program 107 registers information of an application server in a standby server registration management table 173 (S112), requests the standby servers 150 and 155 to register active server information (S102), and then enters an active server registration completion waiting state (S103).

To register active server information in a plurality of standby servers, an order in which the active server information is registered may be set to the standby servers. Active server information may also be registered in standby servers round robin to avoid concentration of registration requests to the same standby server. In the case where an order of priority can be set in cluster programs of the standby servers, the priority order may be notified in the registration request order and set to cluster program switching definitions upon registration (S109). The allocation of the active servers is thus balanced among the standby servers.

The active server configuration management program 161 of each standby server receives an active server information registration request (S107), registers received active server information in the active server configuration management table 171 (S108), registers cluster program switching definitions 172 (S109), and then notifies the completion of the active server registration (S110). Thereafter, the active server configuration management program 161 notifies the application server program 103 of the completion of the active server information registration through the active server information notification line 134 (S111).

When the configuration information notification program 107 that is in the active server registration completion waiting state (S103) receives an active server information registration completion notification from the active server configuration management program 161 of each of the standby servers 150 and 155, the configuration information notification program 107 updates the standby server registration management table 173 (S113) and ends the processing.

As the processing by the configuration information notification program 107 is completed, the application server program 103 notifies the completion of the active server registration (S104). The application server program 103 then executes application server boot processing (S105), and displays a message informing that the application server booting processing has been completed (S106).

Instead of waiting for the active server configuration management program 161 of every standby server (here, 150 and 155) to send an active server information registration completion notification, the application server program 103 may notify the completion of the active server registration and execute application server boot processing when an active server information registration completion notification is received from the active server configuration management program 161 of one standby server. Since at least one standby server is ready at this point, an application executed in an application server can be taken over if a failure occurs in the application server.

In the active server deletion processing of FIG. 5, the application server program 103 of the active server 100 requests the standby servers 150 and 155 to delete active server information (S401), and then enters an active server deletion completion waiting state (S402).

The active server configuration management program 161 of each standby server receives the active server information deletion request (S407), deletes data of an application server that is requested to be deleted from the cluster program switching definitions 172 and then from the active server configuration management table 171 (S408 and S409), and notifies the completion of the active server deletion (S410). The active server configuration management program 161 then notifies the application server program 103 of the completion of the active server information deletion through the active server information notification line 134 (S411).

When the configuration information notification program 107 that is in the active server deletion completion state (S403) receives an active server information deletion completion notification from the active server configuration management program 161 of each of the standby servers 150 and 155, the configuration information notification program 107 deletes information of the application server from the standby server registration management table 173 (S412), and ends the processing.

As the processing by the configuration information notification program 107 is completed, the application server program 103 notifies the completion of the active server information deletion (S404). The application server program 103 then executes application server shutdown processing (S405), and displays a message informing that the application server shutdown processing has been completed (S406).

In the active server deletion processing, the processing of deleting an application server is not executed until an active server information deletion completion notification is received from the active server configuration management program 161 of every standby server (here, 150 and 155). This prevents a standby server that does not know of the shutdown of the application server from acting in an uncontrolled manner.

As described above, the standby servers 150 and 155 in the second embodiment each execute the active server configuration management program 161. The active server 100 sends active server information to the active server configuration management program 161 of every standby server (here, 150 and 155) when an application server is activated. Receiving the active server information, the active server configuration management program 161 updates information in the cluster program switching definitions 172 to prepare for a recovery processing request sent from the active server. In the second embodiment, a plurality of standby servers are thus notified of the addition of an active server, which enables an N:M standby cluster system configuration to automatically update the active server configuration management table 171 and the cluster program switching definitions 172, and to perform recovery processing on a plurality of active servers where failures have occurred concurrently.

While the present invention has been described in detail and pictorially in the accompanying drawings, the present invention is not limited to such detail but covers various obvious modifications and equivalent arrangements, which fall within the purview of the appended claims.

What is claimed is:

1. A computer configuration management method for a computer system having a plurality of active servers and at least one standby server which, when a failure occurs in one of the active servers, recovers transaction processing that has been executed in the failed active server, comprising:
receiving, from one of the active servers, by the standby server, a request for registration of the active server, the request including information about the active server and information about a recovery program that is executed when a failure occurs in the active server;
storing, in a storage unit, by the standby server, the information about the active server and the information about the recovery program based on the received request for registration; and
sending, from the standby server, to the active server that has issued the request, information indicating that the active server has successfully been registered in the standby server.

2. The computer configuration management method according to claim 1,
wherein the computer system has a plurality of standby servers,
the computer configuration management method further comprising:
sending, from each of the active servers, a registration request of the active server to the plurality of standby servers;
storing, in the storage unit, by each of the standby servers, information about the active server that has issued the request and information about a recovery program for recovering the active server
sends, to the active server that has issued the request, information indicating that the active server has been successfully registered in the standby server; and
booting up, by the active server, an application server when receiving the information indicating the successful registration of the active server in the standby server from the standby server to which the registration request has been issued.

3. The computer configuration management method according to claim 1, further comprising:
deleting, by the standby server, from the storage unit, information of the active server in accordance with the active server information including in the received registration deletion request when receiving a registration request to delete the active server registration which includes information of the active server to be deleted; and
sending, from the standby server, to the active server that has issued the registration deletion request, information indicating that the registration of the active server has been deleted successfully after deleting the active server information from the storage unit.

4. The computer configuration management method according to claim 3,
wherein the computer system has a plurality of standby servers,
the computer configuration management method further comprising:
sending, from each of the active servers, an active server registration deletion request to the plurality of standby servers, the request including information of the active server to be deleted,
deleting, by each of the standby servers, from the storage unit, information of the active server in accordance with the active server information included in the received active server registration deletion request
sends, to the active server that has issued the request, information indicating that the registration of the active server has been deleted successfully, and
shutting down, by the active server, an application that is being executed in the active server when receiving the information indicating the successful deletion of the registration of the active server from every standby server to which the registration deletion request has been issued.

5. A computer program product having computer code capable of read by standby server implemented in a computer system having a plurality of active servers and a standby server to cause the standby server to manage the active servers, the standby server which, when a failure occurs in one of the active servers, recovers transaction processing that has been executed in the failed active server, the computer code causing the standby server to execute the steps of:
receiving a registration request from one of the active servers
storing, in a storage unit, information about the active server as well as information about a recovery program for recovering the active server based on the received registration request; and
sending, to the active server that has issued the registration request, information indicating that the active server has successfully been registered in the standby server.

6. The program according to claim 5, the computer code further causing the standby server to execute the steps of:
receiving a deletion registration request to delete the active server registration which includes information of the active server to be deleted,
deleting, from the storage unit, information of the active server in accordance with the active server information included in the received registration deletion request; and
after deleting the active server information from the storage unit, sending, to the active server that has issued the request, information indicating that the registration of the active server has been deleted successfully.

7. A standby server implemented in a computer system having a plurality of active servers to recover transaction processing that was being executed in one of the active servers when a failure occurred in the active server, comprising:
a processor for performing processing;
a storage unit connected to the processor; and
a communication interface connected to the processor,
wherein the processor, for managing configurations of the active servers:
receives a registration request from one of the active servers, the request including information about the active server and information about a recovery program that is executed when a failure occurs in the active server;
stores, in the storage unit, the information about the active server and the information about the recovery program based on the received registration request; and
sends, to the active server that has issued the request, information indicating that the active server has successfully been registered in the standby server.

8. The standby server according to claim 7, wherein the processor:
when receiving a registration deletion request to delete the active server registration which includes information of the active server to be deleted, deletes, from the storage unit, information of the active server in accordance with the active server information that is included in the received registration deletion request; and
after deleting the active server information from the storage unit, sends, to the active server that has issued the request, information indicating that the active server registration has been deleted successfully.

9. A computer system, comprising:
a plurality of active servers which provide applications by executing a program; and
a standby server which, when a failure occurs in one of the active servers, recovers transaction processing that has been executed in the failed active server,
wherein the active servers each send an active server registration request to the standby server, the request including information about the active server that has issued the request and information about a recovery program that is executed when a failure occurs in the active server,
wherein, when receiving the registration request of the active server from the active server, the standby server stores, in a storage unit, the information about the active server and the information about the recovery program that are included in the received registration request,
wherein, after registering the active server, the standby server sends, to the active server that has issued the request, information indicating that the active server has successfully been registered in the standby server, and
wherein, when receiving the information indicating the successful registration of the active server from the standby server to which the registration request has been issued, the active server boots up an application server.

10. The computer system according to claim 9,
wherein, when receiving a registration deletion request to delete the active server registration which includes information of the active server to be deleted, the standby server deletes, from the storage unit, information of the active server in accordance with the active server information included in the received registration deletion request, and
wherein, after deleting the active server information from the storage unit, the standby server sends, to the active server that has issued the request, information indicating that the registration of the active server has been deleted successfully.

11. The computer system according to claim 10,
wherein the computer system comprises a plurality of standby servers,
wherein the active servers each send an active server registration deletion request to the plurality of standby servers, the request including information of the active server to be deleted,
wherein each standby server deletes, from the storage unit, information about the active server in accordance with the active server information included in the received active server registration deletion request and sends, to the active server that has issued the request, information indicating that the registration of the active server has been deleted successfully, and
wherein, receiving the information indicating the successful deletion of the registration of the active server from every standby server to which the registration deletion request has been issued, the active server shuts down an service application that is being executed in the active server.

12. A computer system, comprising:
a plurality of active servers which provide applications by executing program; and
a standby server which, when a failure occurs in one of the active servers, recovers transaction processing that has been executed in the failed active server,
wherein the active servers each send an active server registration deletion request to the standby server, the request including information about the active server to be deleted,
wherein, when receiving the active server registration deletion request, the standby server deletes, from a storage unit, information about the active server in accordance with the active server information included in the received registration deletion request,
wherein, after deleting the active server information from the storage unit, the standby server sends, to the active server that has issued the request, information indicating that the active server registration has been deleted successfully, and
wherein, receiving the information indicating the successful deletion of the active server registration from the standby server to which the registration deletion request has been issued, the active server shuts down an service application that is being executed in the active server.
